(19) United States
(12) Patent Application Publication
(10) Pub. No.: US 2017/0092952 A1
(43) Pub. Date: Mar. 30, 2017

(54) ELECTRODE MATERIAL FOR LITHIUM-ION RECHARGEABLE BATTERY, ELECTRODE, LITHIUM-ION RECHARGEABLE BATTERY, AND METHOD FOR MANUFACTURING ELECTRODE MATERIAL FOR LITHIUM-ION RECHARGEABLE BATTERY

(71) Applicant: Sumitomo Osaka Cement Co., Ltd., Tokyo (JP)

(72) Inventors: HIROFUMI YASUMIISHI, Tokyo (JP); RYUUTA YAMAYA, Tokyo (JP)

(21) Appl. No.: 15/075,511

(22) Filed: Mar. 21, 2016

(30) Foreign Application Priority Data
Sep. 30, 2015 (JP) 2015-192839

(51) Int. Cl. H01M 4/58; H01M 10/0525; H01M 4/485; H01M 4/62; H01M 4/136

(52) U.S. Cl. CPC H01M 4/5825; H01M 4/625; H01M 4/136; H01M 4/485; H01M 10/0525; H01M 2220/20; H01M 2220/30

(57) ABSTRACT

[Problem]

To provide an electrode material for a lithium-ion rechargeable battery capable of improving the high-rate characteristics without deteriorating the capacity retention. In addition, and to provide an electrode including the electrode material for a lithium-ion rechargeable battery, a lithium-ion rechargeable battery including the electrode as a cathode, and a method for manufacturing the electrode material for a lithium-ion rechargeable battery.

Means for Solving the Problem

An electrode material for a lithium-ion rechargeable battery in which surfaces of inorganic particles represented by LiFeₓMn_{1-x-y}M_{y}PO₄ (0.05≦x≦1.0, 0≦y≦0.14, here, M represents at least one element selected from Mg, Ca, Co, Sr, Ba, Ti, Zn, B, Al, Ga, In, Si, Ge, and rare earth elements) are coated with a carbonaceous film, and a standard deviation (n=5) of a G/D ratio obtained from a Raman spectrum spectroscopic measurement is 0.01 or more and 0.05 or less.

### CROSS-REFERENCE TO RELATED APPLICATIONS

This application claims the benefit of Japanese Patent Application No. 2015-192839 filed Sep. 30, 2015, the disclosure of which is herein incorporated by reference in its entirety.

### TECHNICAL FIELD

The present invention relates to an electrode material for a lithium-ion rechargeable battery, an electrode, a lithium-ion rechargeable battery, and a method for manufacturing an electrode material for a lithium-ion rechargeable battery.

### BACKGROUND ART

Studies are underway regarding secondary batteries to be used for mobile electronic devices or hybrid vehicles. As typical secondary batteries, a lead battery, an alkali rechargeable battery, a lithium-ion battery, and the like are known. Among a variety of secondary batteries, a lithium secondary battery for which a lithium-ion rechargeable battery is used has advantages of a high output and a high energy density.

As a cathode material used for a lithium-ion rechargeable battery, phosphates which include Li and a transition metal and have an olivine structure are known. For example, an iron-based olivine-type compound has excellent electrochemical characteristics or stability and thus, currently, is employed for a variety of usages starting from a cathode material for a lithium-ion rechargeable battery for stationary usage or in-vehicle usage.

In recent years, there has been a demand for improving performance of a lithium-ion rechargeable battery and a variety of studies have been underway. For example, in a case in which a lithium-ion rechargeable battery is used in a region with a high electric current density, there is a demand for additional improvement of electron conductivity in order for improvement of performance. In response to the above-described demand relating to properties, a technique for coating the surface of a cathode active material with a carbonaceous material (hereinafter, in some cases, simply referred to as carbon coating) is known (for example, Patent Documents 1 and 2).

### PRIOR ART REFERENCES

### Patent Documents

[Patent Document 1] Japanese Unexamined Patent Application, First Publication No. 2002-075364.

[Patent Document 2] Japanese Unexamined Patent Application, First Publication No. 2009-295465.

### SUMMARY OF THE INVENTION

### Problems to be Solved by the Invention

Meanwhile, in recent years, for an electrode material of a lithium-ion rechargeable battery, there has been a demand for improvement of “high-rate characteristics”. Here, in the present specification, the “high-rate characteristics” refer to “10 C discharge capacity”.

Even for an electrode active material having the above-described olivine structure, there is a demand for improvement of the high-rate characteristics. In addition, for an electrode active material, there is a demand for a capability of maintaining a high capacity in spite of repetition of charging and discharging in a case in which the electrode active material is used as a material for forming a lithium-ion rechargeable battery. Here, in the present specification, the ratio of the capacity of an electrode material attenuated due to repetition of charging and discharging to the initial capacity will be referred to as the “capacity retention”.

The present invention has been made in consideration of the above-described circumstances, and an object of the present invention is to provide an electrode material for a lithium-ion rechargeable battery capable of improving the high-rate characteristics without deteriorating the capacity retention. In addition, another object of the present invention is to provide an electrode including the above-described electrode material for a lithium-ion rechargeable battery, a lithium-ion rechargeable battery including the above-described electrode as a cathode, and a method for manufacturing the electrode material for a lithium-ion rechargeable battery.

The present inventors and the like carried out intensive studies and consequently found that, when a temperature distribution is generated in a calcination capsule by controlling the granulation conditions and the calcination conditions of secondary particles, and an electrode is produced by including a cathode active material in which individual agglomerates made of the electrode active material have different carbon crystallinities, the direct current resistance (DCR) of a lithium-ion rechargeable battery can be decreased, and completed the present invention.

That is, in order to achieve the above-described objects, according to an aspect of the present invention, there is provided an electrode material for a lithium-ion rechargeable battery in which surfaces of inorganic particles represented by LiFeₓMn_{1-x-y}M_{y}PO₄ (0.05≦x≦1.0, 0≦y≦0.14, here, M represents at least one element selected from Mg, Ca, Co, Sr, Ba, Ti, Zn, B, Al, Ga, In, Si, Ge, and rare earth elements) are coated with a carbonaceous film, and a standard deviation (n=5) of a G/D ratio obtained from a Raman spectrum spectroscopic measurement is 0.01 or more and 0.05 or less.

In the aspect of the present invention, the electrode material for a lithium-ion rechargeable battery is a spherical granulated body made of secondary particles formed by agglomerating primary particles of the inorganic particles, and, in the spherical granulated body, surfaces of the primary particles of the inorganic particles are coated with carbon and the carbon is interposed among a plurality of the primary particles.

In the aspect of the present invention, in a secondary battery in which a cathode in which the electrode material for a lithium-ion rechargeable battery is used as a cathode active material and an anode made of LTO are used, a discharge capacity obtained when the secondary battery is charged and discharged at 25° C. and at an electric current rate of 10 C is 110 mAh/g or higher.

According to another aspect of the present invention, there is provided an electrode for which the electrode material for a lithium-ion rechargeable battery is used as a material for forming the electrode.

According to still another aspect of the present invention, there is provided a lithium-ion rechargeable battery including the electrode as a cathode.

According to an aspect of the present invention, there is provided a method for manufacturing an electrode material for a lithium-ion rechargeable battery including a step of generating a granulated body by spraying and drying a slurry including at least one of an electrode active material represented by LiFeₓMn_{1-x-y}M_{y}PO₄ (0.05≦x≦1.0, 0≦y≦0.14, here, M represents at least one element selected from Mg, Ca, Co, Sr, Ba, Ti, Zn, B, Al, Ga, In, Si, Ge, and rare earth elements) and a precursor of the electrode active material and an organic compound and a step of loading the granulated body in a calcination vessel and thermally treating the granulated body in an inert atmosphere or a reducing atmosphere at a temperature of 700° C. or more and 1,000° C. or less, in which a concentration of the electrode active material and the precursor of the electrode active material in the slurry is 10% by mass or more and 30% by mass or less.

### Effects of the Invention

According to the present invention, it is possible to provide an electrode material for a lithium-ion rechargeable battery capable of improving the high-rate characteristics without deteriorating the capacity retention. In addition, it is possible to provide an electrode including the above-described electrode material for a lithium-ion rechargeable battery, a lithium-ion rechargeable battery including the above-described electrode as a cathode, and a method for manufacturing the electrode material for a lithium-ion rechargeable battery.

### EMBODIMENTS FOR CARRYING OUT THE INVENTION

Hereinafter, the electrode material for a lithium-ion rechargeable battery, the electrode, the lithium-ion rechargeable battery, and the method for manufacturing an electrode material for a lithium-ion rechargeable battery of the present embodiment will be described. Meanwhile, the present embodiment is a specific description for easier understanding of the gist of the present invention and, unless particularly otherwise described, does not limit the present invention.

Electrode Material for Lithium-Ion Rechargeable Battery

In the electrode material for a lithium-ion rechargeable battery of the present embodiment (hereinafter, in some cases, simply referred to as the “electrode material”), the surfaces of inorganic particles represented by LiFeₓMn_{1-x-y}M_{y}PO₄ (0.05≦x≦1.0, 0≦y≦0.14, here, M represents at least one element selected from Mg, Ca, Co, Sr, Ba, Ti, Zn, B, Al, Ga, In, Si, Ge, and rare earth elements) are coated with a carbonaceous film, and the standard deviation (n=5) of the G/D ratio obtained from a Raman spectrum spectroscopic measurement is 0.01 or more and 0.05 or less.

In the electrode material of the present embodiment, as the inorganic particles, an electrode active material that is LiFeₓMn_{1-x-y}M_{y}PO₄ (0.05≦x≦1.0, 0≦y≦0.14, here, M represents at least one element selected from Mg, Ca, Co, Sr, Ba, Ti, Zn, B, Al, Ga, In, Si, Ge, and rare earth elements) is used.

Regarding the sizes of the inorganic particles, for example, the average particle diameter of the primary particles is preferably 0.001 μm or more and 20 μm or less and more preferably 0.005 μm or more and 5 μm or less.

When the average particle diameter of the primary particles is 0.001 μm or larger, it is possible to sufficiently coat the surfaces of the primary particles with a carbon thin film, and it becomes possible to realize sufficient charge and discharge performance while preventing the discharge capacity from being decreased at a high-speed charge and discharge. On the other hand, when the average particle diameter of the primary particles is 20 μm or smaller, the internal resistance of the primary particle does not become too great, and the discharge capacity does not become sufficient at a high-speed charge and discharge.

Meanwhile, in the present embodiment, the average particle diameter refers to the number-average particle diameter. The average particle diameter of the primary particles can be measured using a laser diffraction scattering-type particle size distribution measurement instrument or the like.

In the electrode material of the present embodiment, the surfaces of the inorganic particles are coated with carbon deposited in a film form. The carbon film coating the surfaces of the inorganic particles will be referred to as the “carbonaceous film”.

The thickness of the carbonaceous film coating the surfaces of the inorganic particles is preferably 0.1 nm or more and 20 nm or less.

When the thickness of the carbonaceous film is 0.1 nm or more, the thickness of the carbonaceous film does not become too thin, and the electron conductivity of the carbonaceous film is sufficiently improved, which is preferable. In addition, when the thickness of the carbonaceous film is 20 nm or less, battery activity, for example, the battery capacity per unit mass of the electrode material, does not decrease, which is preferable.

The electrode material of the present embodiment is a spherical granulated body made of secondary particles formed by agglomerating the primary particles of the inorganic particles. In the spherical granulated body, the surfaces of the primary particles of the inorganic particles are coated with carbon and the carbon is interposed among a plurality of the primary particles.

In addition, in the electrode material of the present embodiment, in a case in which a Raman spectrum spectroscopic measurement is carried out, the standard deviation (n=5) of the intensity ratio (G/D ratio) of the graphite peak (G) derived from carbon to the disorder peak (D) is 0.01 or more and 0.05 or less.

According to the Raman spectrum spectroscopic analysis, it is possible to evaluate the crystallinity of the carbonaceous film in the electrode material.

While described in detail, the electrode material of the present embodiment can be manufactured by calcinating a raw material including an organic compound which is a raw material of the carbonaceous film and at least one of the electrode active material and a precursor of the electrode active material. From the present inventors' studies, it was found that, when the temperature varies depending on positions in a calcination capsule (calcination vessel) used for the calcination (a temperature distribution is generated) during calcination, in an electrode material to be obtained, the crystallinity of the carbonaceous film varies depending on positions in the calcination vessel. In addition, it was found that the above-described difference in the crystallinity is clarified by carrying out a Raman spectrum spectroscopic analysis on the electrode material in a form of a difference between numeric values attributed to a difference between measurement points.

In a case in which the average value of the G/D ratio obtained by carrying out a Raman spectroscopic analysis is high, that is, in a case in which the crystallinity of the carbonaceous film is relatively high, while the electron conductivity of the carbonaceous film improves, there is a concern that the mobility of Li ions in the carbonaceous film may deteriorate.

On the other hand, in a case in which the average value of the G/D ratio is low, that is, in a case in which the crystallinity of the carbonaceous film is relatively low, since the carbonaceous film is amorphous carbon, while the mobility of Li ions increases, the electron conductivity deteriorates.

In the electrode material of the present embodiment, in order to increase both electron conductivity and ion conductivity, an electrode material having both electron conductivity and ion conductivity is produced by using the standard deviation of the G/D ratio obtained from a Raman spectroscopic analysis as a criterion and controlling the G/D ratio. In such a case, the electrode material of the present embodiment is capable of realizing high-rate characteristics. In addition, it is possible to prevent an extremely biased electric current distribution and to improve cycle characteristics at a high-speed charge and discharge.

The powder resistance of the electrode material of the present embodiment is preferably 200 Ω·cm or less.

The powder resistance of the electrode material can be measured using four point measurements in which the electrode material is put into a mold and pressurized under a pressure of 50 MPa, and four probes are brought into contact with the surfaces of this sample.

When the powder resistance of the electrode material of the present embodiment is 200 Ω·cm or less, it is possible to improve the electron conductivity of an electrode for a lithium-ion rechargeable battery to which the electrode material is applied.

Method for Manufacturing Electrode Material for Lithium-Ion Rechargeable Battery

Next, a method for manufacturing an electrode material for a lithium-ion rechargeable battery of the present embodiment will be described.

The method for manufacturing an electrode material for a lithium-ion rechargeable battery of the present embodiment is a method in which a granulated body is generated by spraying and drying a slurry including at least one of an electrode active material represented by LiFeₓMn_{1-x-y}M_{y}PO₄ (0.05≦x≦1.0, 0≦y≦0.14, here, M represents at least one element selected from Mg, Ca, Co, Sr, Ba, Ti, Zn, B, Al, Ga, In, Si, Ge, and rare earth elements) and a precursor of the electrode active material and an organic compound, the granulated body is thermally treated in an inert atmosphere or a reducing atmosphere at a temperature of 700° C. or more and 1,000° C. or less, thereby forming a carbonaceous film on the surface of the electrode active material.

At this time, when the particle sizes, the particle size distribution, and the density in the granulated body obtained by means of drying, which is not yet thermally treated, are adjusted to be desired values, the bulk density of the granulated body changes. Therefore, the temperature distribution in a capsule generated when the granulated body is loaded into the calcination capsule used for the thermal treatment can be controlled by adjusting the particle sizes, the particle size distribution, and the density in the granulated body and controlling the bulk density of the granulated body. In such a case, it is possible to set the standard deviation (n=5) of the G/D ratio of the carbonaceous film in an electrode material to be obtained to 0.01 or more and 0.05 or less.

As the electrode active material represented by LiFeₓMn_{1-x-y}M_{y}PO₄ which is used in the method for manufacturing an electrode material of the present embodiment, an electrode active material manufactured using a method of the related art such as a solid-phase method, a liquid-phase method, or a gas-phase method can be used. As the precursor, a wide range of precursors can be used as long as the precursors are raw materials used when LiFeₓMn_{1-x-y}M_{y}PO₄ is manufactured using the above-described method of the related art.

The electrode active material may be crystalline particles or amorphous particles or may be mixed particles of crystalline particles and amorphous particles. Here, the reason why the electrode active material may be amorphous particles is that, when the amorphous electrode active material is thermally treated at a temperature of 500° C. or more and 1,000° C. or less, preferably, 800° C. or more and 900° C. or less in an inert atmosphere or a reducing atmosphere, the electrode active material is crystallized.

The electrode active material has a particulate shape. The sizes of the particles of the electrode active material (electrode active material particles) are not particularly limited, but the average particle diameter of the primary particles is preferably 0.001 μm or more and 20 μm or less and more preferably 0.005 μm or more and 5 μm or less.

When the average particle diameter of the primary particles of the electrode active material is 0.001 μm or larger, it is easy to sufficiently coat the surfaces of the primary particles with a carbon thin film, the discharge capacity becomes high at a high charge-discharge rate, and it is possible to realize sufficient charge and discharge rate performance. On the other hand, when the average particle diameter of the primary particles of the electrode active material particles is 20 μm or smaller, the internal resistance of the primary particles is small, and thus the discharge capacity at a high charge-discharge rate becomes sufficient.

For the electrode material, the electrode active material particles coated with the carbonaceous film may be used without any changes, but secondary particles obtained by collecting a plurality of the electrode active material particles coated with the carbonaceous film are preferably used. The shape of the secondary particle is not particularly limited, but is preferably a spherical shape, particularly, a truly spherical shape.

Here, the reason for the shape of the electrode material being preferably a spherical shape is that it is possible to decrease the amount of a solvent when the electrode material, an organic compound such as a binder resin, and, if necessary, the solvent are mixed together. In addition, when the shape of the electrode material is a spherical shape, the surface area of the electrode material is minimized, and thus it is possible to minimize the blending amount of the organic compound such as the binder resin which is added as a component of the electrode material, and the internal resistance of a cathode to be obtained can be decreased, which is preferable.

Furthermore, since it is easy to closely pack the electrode material, the amount of the electrode material packed per unit volume becomes great, and thus it is possible to increase the electrode density, and consequently, the capacity of a lithium-ion rechargeable battery can be increased, which is preferable.

As the organic compound used in the method for manufacturing an electrode material of the present embodiment, it is possible to use a variety of compounds as long as the organic compound is decomposed and reacted by means of a thermal treatment under conditions described below, thereby generating carbon. Examples of the organic compound include polyvinyl alcohols, polyvinylpyrrolidone, cellulose, starch, gelatin, carboxymethyl cellulose, methyl cellulose, hydroxymethyl cellulose, hydroxyethyl cellulose, polyacrylic acid, polystyrene sulfonate, polyacrylamide, polyvinyl acetate, glucose, fructose, galactose, mannose, maltose, sucrose, lactose, glycogen, pectin, alginic acid, glucomannan, chitin, hyaluronic acid, chondroitin, agarose, polyether, and polyhydric alcohols.

Examples of the polyhydric alcohols include polyethylene glycol, polypropylene glycol, polyglycerin, glycerin, and the like.

In the method for manufacturing an electrode material of the present embodiment, first, at least one of the electrode active material and the precursor of the electrode active material and the organic compound are dissolved or dispersed in the solvent, thereby producing a homogeneous slurry. During the dissolution or dispersion, a dispersing agent may be added thereto.

At this time, the ratio (solid content concentration) between the electrode active material and the precursor of the electrode active material in the slurry including at least one of the electrode active material and the precursor of the electrode active material is controlled to be 10% by mass or more and 30% by mass or less. When the concentration of the slurry is controlled to be in a range of the solid content concentration, it is possible to control the particle sizes and the density in a granulated body to be obtained by means of spraying and drying described below to be in a desired range.

When the total mass of the organic compound is converted to the amount of carbon, the blending ratio between the electrode active material and the precursor of the electrode active material and the organic compound is preferably 0.6 parts by mass or more and 10 parts by mass or less and more preferably 0.8 parts by mass or more and 4.0 parts by mass or less with respect to 100 parts by mass of the electrode active material.

Here, when the blending ratio of the organic compound in terms of the amount of carbon is less than 0.6 parts by mass, the coating ratio of the surface of the electrode active material with the carbonaceous film generated by the thermal treatment of the organic compound becomes less than 80%, the discharge capacity becomes low at a high charge-discharge rate in a case in which a battery is formed, and it becomes difficult to realize sufficient charge and discharge rate performance. On the other hand, when the blending ratio of the organic compound in terms of the amount of carbon exceeds 10 parts by mass, the blending ratio of the electrode active material is relatively decreased, the capacity of a battery is decreased in a case in which the battery is formed, and the bulk density of the electrode active material is increased due to the excessively supported carbonaceous film, and thus the electrode density decreases, and a decrease in the battery capacity of a lithium-ion rechargeable battery per unit volume cannot be ignored.

The solvent that dissolves or disperses the electrode active material or the precursor of the electrode active material and the organic compound is preferably water, and examples of other solvents include alcohols such as methanol, ethanol, 1-propanol, 2-propanol (isopropyl alcohol:IPA), butanol, pentanol, hexanol, octanol, and diacetone alcohol, esters such as ethyl acetate, butyl acetate, ethyl lactate, propylene glycol monomethyl ether acetate, propylene glycol monoethyl ether acetate, and γ-butyrolactone, ethers such as diethyl ether, ethylene glycol monomethyl ether (methyl cellosolve), ethylene glycol monoethyl ether (ethyl cellosolve), ethylene glycol monobutyl ether (butyl cellosolve), diethylene glycol monomethyl ether, and diethylene glycol monoethyl ether, ketones such as acetone, methyl ethyl ketone (MEK), methyl isobutyl ketone (MIBK), acetyl acetone, and cyclohexanone, amides such as dimethyl formamide, N,N-dimethylacetoacetamide, and N-methyl pyrrolidone, glycols such as ethylene glycol, diethylene glycol, and propylene glycol, and the like. These solvents may be singly used or in a mixture form of two or more solvents.

A method for dissolving or dispersing the electrode active material or the precursor of the electrode active material and the organic compound is not particularly limited as long as the electrode active material or the precursor of the electrode active material is uniformly dispersed, and the organic compound is dissolved or dispersed and, for example, a method in which a medium stirring-type dispersion device in which medium particles are stirred at a high speed such as a planetary ball mill, a vibratory ball mill, a beads mill, a paint shaker, or an attritor is used is preferred.

During the dissolution or the dispersion, it is preferable to disperse the electrode active material or the precursor of the electrode active material in a primary particle form and then stir the organic compound so as to be dissolved. In such a case, the surfaces of the primary particles of the electrode active material or the precursor of the electrode active material are coated with the organic compound, and consequently, carbon derived from the organic compound becomes uniformly interposed among the primary particles of the electrode active material.

Next, the slurry is sprayed using a spray-pyrolysis method and dried in a high-temperature atmosphere, for example, in the air at a temperature of 70° C. or more and 250° C. or less, thereby generating a granulated body.

In the spray-pyrolysis method, in order to generate a substantially spherical granulated body by rapidly drying the slurry, the particle diameter of a liquid droplet during the spraying is preferably 0.05 μm or more and 500 μm or less.

In addition, regarding the particle size distribution in the granulated body obtained in the above-described manner, it is preferable that D90 is 10 μm or more and 14 μm or less, D50 is 3 μm or more and 7 μm or less, and D10 is 0.5 μm or more and 2.0 μm or less.

Next, the granulated body is thermally treated in an inert atmosphere or a reducing atmosphere at a temperature of 700° C. or more and 1,000° C. or less and preferably 700° C. or more and 800° C. or less.

The inert atmosphere is preferably an atmosphere formed of an inert gas such as nitrogen (N₂) or argon (Ar), and, in a case in which it is necessary to further suppress oxidation of the granulated body, a reducing atmosphere including a reducing gas such as hydrogen (H₂) is preferred.

Here, the reason for the thermal treatment temperature being preferably 700° C. or more and 1,000° C. or less is as described below. When the thermal treatment temperature is lower than 700° C., the organic compound is not sufficiently decomposed and reacted, the organic compound is not sufficiently carbonized, and a decomposed and reacted substance being generated turns into an organic decomposed substance having a high resistance, which is not preferable. On the other hand, when the thermal treatment temperature exceeds 1,000° C., a component constituting the electrode active material, for example, lithium (Li), evaporates and thus the composition deviates, additionally, grain growth in the electrode active material is accelerated, the discharge capacity at a high charge and discharge rate decreases, and it becomes difficult to realize a sufficient charge and discharge rate performance.

In addition, the thermal treatment duration is not particularly limited as long as the organic compound is sufficiently carbonized and, for example, is set to 0.1 hours or more and 10 hours or less.

In a case in which the precursor of the electrode active material is included in the granulated body, the precursor of the electrode active material turns into an electrode active material. Meanwhile, the organic compound is decomposed and reacted during the thermal treatment so as to generate carbon, and the carbon is attached to the surface of the electrode active material, thereby forming a carbonaceous coating. Therefore, the surface of the electrode active material is coated with the carbonaceous film.

Here, in a case in which the electrode active material includes lithium as a constitutional component, as the thermal treatment duration increases, lithium diffuses into the carbonaceous film from the electrode active material and is present in the carbonaceous film, and thus the conductivity of the carbonaceous film further improves, which is preferable.

However, when the thermal treatment duration becomes too long, abnormal grain growth occurs or an electrode active material in which lithium is partially deficient is generated, and thus the performance of the electrode active material degrades. As a result, the characteristics of a battery for which the electrode active material is used degrade, which is not preferable.

Electrode

An electrode of the present embodiment is an electrode formed using the electrode material of the present embodiment. In order to produce the electrode of the present embodiment, the electrode material, a binding agent made of a binder resin, and a solvent are mixed together, thereby preparing a paint for forming the electrode or a paste for forming the electrode. At this time, an auxiliary conductive agent such as carbon black may be added thereto as necessary.

As the binding agent, that is, a binder resin, for example, a polytetrafluoroethylene (PTFE) resin, a polyvinylidene fluoride (PVdF) resin, fluorine rubber, or the like is preferably used.

The blending ratio between the electrode material and the binder resin is not particularly limited, and, for example, the content of the binder resin is set to 1 part by mass or more and 30 parts by mass or less and preferably to 3 parts by mass or more and 20 parts by mass or less with respect to 100 parts by mass of the electrode material.

Examples of the solvent used for the paint for forming the electrode or the paste for forming the electrode include water; alcohols such as methanol, ethanol, 1-propanol, 2-propanol (isopropyl alcohol:IPA), butanol, pentanol, hexanol, octanol, and diacetone alcohol; esters such as ethyl acetate, butyl acetate, ethyl lactate, propylene glycol monomethyl ether acetate, propylene glycol monoethyl ether acetate, and γ-butyrolactone; ethers such as diethyl ether, ethylene glycol monomethyl ether (methyl cellosolve), ethylene glycol monoethyl ether (ethyl cellosolve), ethylene glycol monobutyl ether (butyl cellosolve), diethylene glycol monomethyl ether, and diethylene glycol monoethyl ether; ketones such as acetone, methyl ethyl ketone (MEK), methyl isobutyl ketone (MIBK), acetyl acetone, and cyclohexanone; amides such as dimethyl formamide, N,N-dimethylacetoacetamide, and N-methyl pyrrolidone; glycols such as ethylene glycol, diethylene glycol, and propylene glycol; and the like. These solvents may be singly used or in a mixture form of two or more solvents.

Next, the paint for forming the electrode or the paste for forming the electrode is applied to one surface of a metal foil and then is dried, thereby obtaining a metal foil including a coated film made of a mixture of the electrode material and the binder resin formed on one surface.

Next, the coated film is pressed under pressure and dried, thereby producing a current collector (electrode) including an electrode material layer on one surface of the metal foil.

In the above-described manner, the electrode of the present embodiment can be produced.

Lithium-Ion Rechargeable Battery

A lithium-ion rechargeable battery of the present invention is a battery including the electric collector (electrode) of the present embodiment which includes an electrode material layer on one surface of a metal foil as a cathode.

When the lithium-ion rechargeable battery of the present embodiment is formed using the electrode material of the present invention, intercalation and deintercalation of Li becomes favorable, and thus stabilized charge and discharge cycle characteristics or high stability can be realized.

According to the electrode material for a lithium-ion rechargeable battery having the above-described constitution, it is possible to provide an electrode material for a lithium-ion rechargeable battery capable of improving the high-rate characteristics without deteriorating the capacity retention.

In addition, according to the electrode having the above-described constitution, since the above-described electrode material for a lithium-ion rechargeable battery is included, it is possible to provide a high-quality electrode capable of improving the high-rate characteristics without deteriorating the capacity retention.

In addition, according to the lithium-ion rechargeable battery having the above-described constitution, since the above-described electrode is included, it is possible to provide a high-quality lithium-ion rechargeable battery capable of improving the high-rate characteristics without deteriorating the capacity retention.

In addition, according to the above-described method for manufacturing an electrode material for a lithium-ion rechargeable battery, it is possible to easily manufacture an electrode material for a lithium-ion rechargeable battery capable of improving the high-rate characteristics without deteriorating the capacity retention.

Hitherto, the preferred embodiment according to the present invention has been described with reference to the accompanying drawings, but it is needless to say that the present invention is not limited to the example. A variety of shapes, combinations, and the like of constitutional members described in the above-described example are simply examples and can be modified in a variety of manners on the basis of a design requirement and the like within the scope of the gist of the present invention.

### EXAMPLES

Hereinafter, the present invention will be further described using examples, but the present invention is not limited to the following examples.

### Example 1

lithium acetate (LICH₃COO) (4 mol), iron (II) sulfate (FeSO₄) (2 mol), and phosphoric acid (H₃PO₄) (2 mol) were mixed with water (2 L) so that the total amount reached 4 L, thereby preparing a homogeneous slurry-form mixture A. Next, the mixture A was stored in a pressure-resistant airtight container having a capacity of 8 L and was hydrothermally synthesized at 120° C. for one hour. Next, the obtained precipitate was washed with water, thereby obtaining a cake-form precursor of electrode active material.

Next, an aqueous solution of polyvinyl alcohol produced by dissolving the precursor of the electrode active material (15 g, solid content-equivalent) and polyvinyl alcohol (10 g) in water (100 g) was injected into a ball mill including zirconia balls (250 g) having a diameter of 5 mm and was mixed for 12 hours, thereby preparing a homogeneous slurry.

Next, this slurry was sprayed and dried in the atmosphere at 180° C., and the obtained dried substance (granulated body) (2.5 kg) was injected into a carbon calcination capsule (volume dimensions: 300×300×150 mm). The dried substance was calcinated in a nitrogen atmosphere at a calcination temperature of 750° C. for 60 minutes, thereby obtaining an electrode material of Example 1 including a carbonaceous film that coated the primary particles of an electrode active material which included LiFePO₄ and had an olivine structure and the surfaces of the primary particles of the electrode active material.

### Example 2

An electrode material of Example 2 was obtained in the same manner as in Example 1 except for the fact that the precursor of the electrode active material (5 g, solid content-equivalent) was used during the preparation of the slurry.

### Example 3

An electrode material of Example 3 was obtained in the same manner as in Example 1 except for the fact that the precursor of the electrode active material (30 g, solid content-equivalent) was used during the preparation of the slurry.

### Comparative Example 1

An electrode material of Comparative Example 1 was obtained in the same manner as in Example 1 except for the fact that the precursor of the electrode active material (75 g, solid content-equivalent) was used during the preparation of the slurry.

### Comparative Example 2

An electrode material of Comparative Example 2 was obtained in the same manner as in Example 1 except for the fact that the precursor of the electrode active material (1 g, solid content-equivalent) was used during the preparation of the slurry.

The electrode materials obtained in the examples and the comparative examples were evaluated by means of the following measurements.

(Solid Content of Precursor)

For the cake-form precursor of the electrode active material obtained after the hydrothermal synthesis, the amount of moisture was measured using a halogen moisture meter, and thus the solid content ratio (% by mass) of the precursor was measured.

(Raman Spectroscopic Analysis)

From an electrode material obtained by means of calcination in a carbon calcination capsule (volume dimensions: 300×300×150 mm), one ear pick of powder was placed on a prepared slide for a Raman spectroscopic measurement using a spatula, the electrode material was sampled respectively from the four corners and center of the calcination capsule, and a Raman spectroscopic measurement was carried out under the following conditions.

<Measurement Conditions>

Instrument: NRS-3100 manufactured by JASCO Corporation

Exposure duration: 50 seconds

Number of times of integration: 10 times

Central frequency: 1,300 cm⁻¹

Slit: 0.01×6 mm

Stepper: OD3

On the basis of a total of five Raman spectroscopic analysis results, the intensity ratios (G/D ratio) of the graphite peak (G) derived from carbon to the disorder peak (D) were respectively obtained, and a standard deviation was obtained.

(BET Specific Surface Area)

For the obtained electrode material, the BET specific surface area was measured using an automatic surface area analyzer (Macsorb HM model-1208 manufactured by Mountech Co., Ltd.).

(Amount of C (Amount of Carbon))

For the obtained electrode material, the amount of carbon was measured using a carbon/sulfur analyzer (EMIA-920V, manufactured by Horiba Ltd.).

(Powder Resistance)

For the obtained electrode material, the powder resistance was measured using a resistivity meter (LORESTA GP MCP-T610 type, manufactured by Mitsubishi Chemical Analytech Co., Ltd.).

(Charge and Discharge Evaluation: 10 C Discharge Capacity)

The electrode material, acetylene black, and polyvinyl chloride are mixed together in a mass ratio of 90:5:5 using the electrode material obtained each of the examples and the comparative examples, and furthermore, N-methyl-2-pyrrolidone was added thereto so that the solid content reached 40% by mass.

The obtained mixture was stirred using a planetary centrifugal mixer manufactured by Thinky at a rotation speed of 2,500 rpm for 10 minutes, thereby producing a slurry.

The obtained slurry was applied onto an Al current collector, and the coated film was dried in a vacuum dryer at 120° C. for 10 hours.

The dried film was cut into an area of 10 cm² (including 9 cm² of a coated portion) and was used as a cathode.

The electrode manufactured using the above-described method was used as a cathode, and an electrode for which lithium titanium oxide (LTO) was used as a material for forming an electrode was used as an anode, thereby producing a Lami cell-type battery.

The produced battery was constant-electric-current-charged at an environmental temperature of 25° C. and at an electric current value of 0.1 C until the voltage of the cathode reached 2.2 V relative to the equilibrium voltage of LTO, and then the charging was finished when the constant electric current charging was switched to constant voltage charge and thus the electric current value reached 0.01 A. After that, discharging was carried out at an electric current value of 0.1 C, and the discharging was finished when the battery voltage reached 1.0 V. The above-described charging and discharging was considered as one cycle, and the 0.1 C charging and discharging was carried out three cycles under the same conditions.

After that, the conditions were changed to charging and discharging at an electric current value of 10 C, and the discharge capacity at the first cycle after the change was measured and used as the 10 C discharge capacity.

The evaluation results of the electrode materials of Examples 1 to 3 and Comparative Examples 1 and 2 are shown in Table 1. Regarding the 10 C discharge capacity, the discharge capacity that was 110 mAh/g or higher was evaluated as favorable.

TABLE 1

| | | G/D | | | | 10 C |
|---|---|---|---|---|---|---|
| | Solid | ratio | BET | | Powder | discharge |
| | content of | standard | specific | | resistance | capacity |
| | precursor | deviation | surface | Amount | (16 kN) | (25° C.) |
| | [%] | (n = 5) | area [m²/g] | of C [%] | [Ω · cm] | [mAh/g] |
| Example 1 | 20 | 0.033 | 13.3 | 1.39 | 65 | 125 |
| Example 2 | 13 | 0.047 | 13.8 | 1.42 | 105 | 125 |
| Example 3 | 29 | 0.021 | 13 | 1.32 | 52 | 127 |
| Comparative | 46 | 0.008 | 12.2 | 1.2 | 25 | 98 |
| Example 1 | | | | | | |
| Comparative | 9.5 | 0.065 | 12.9 | 1.31 | 1,062 | 101 |
| Example 2 | | | | | | |

As a result of the evaluations, it was found that, in the electrode materials of Examples 1 to 3, the standard deviation (n=5) of the G/D ratio fell into a range of 0.01 or more and 0.05 or less, and the 10 C discharge capacity was a high value exceeding 110 mAh/g. In addition, it was separately confirmed that the capacity retention after 300 cycles was not excessively deteriorated.

On the other hand, in the electrode materials of Comparative Examples 1 and 2, the 10 C discharge capacity was low, and the high-rate characteristics were poor.

In addition, it was found that the electrode material of Comparative Example 2 had a high powder resistance value and poor performance.

From the above-described results, it was found that the present invention is useful.

1. An electrode material for a lithium-ion rechargeable battery comprising:
An inorganic particle represented by LiFeₓMn_{1-x-y}M_{y}PO₄, in which 0.05≦x≦1.0, 0≦y≦0.14, M represents at least one element selected from Mg, Ca, Co, Sr, Ba, Ti, Zn, B, Al, Ga, In, Si, Ge, and rare earth elements whose surface being coated with a carbonaceous film, and
a standard deviation (n=5) of a G/D ratio of the particle obtained from a Raman spectrum spectroscopic measurement being 0.01 or more and 0.05 or less.

2. The electrode material for a lithium-ion rechargeable battery according to claim 1,
wherein it is a spherical granulated body made of secondary particles formed by agglomerating primary particles of the inorganic particles, and
in the spherical granulated body, surfaces of the primary particles of the inorganic particles are coated with carbon and the carbon is interposed among a plurality of the primary particles.

3. The electrode material for a lithium-ion rechargeable battery according to claim 1,
wherein, a secondary battery in which a cathode for which the electrode material for a lithium-ion rechargeable battery is used as a cathode active material and an anode made of LTO are used, a discharge capacity obtained when the secondary battery is charged and discharged at 25° C. and at an electric current rate of 10 C is 110 mAh/g or higher.

4. An electrode comprising:
the electrode material for a lithium-ion rechargeable battery according to claim 1 as a material for forming the electrode.

5. A lithium-ion rechargeable battery comprising:
the electrode according to claim 4 as a cathode.

6. A method for manufacturing an electrode material for a lithium-ion rechargeable battery, comprising:
generating a granulated body by spraying and drying a slurry including at least one of an electrode active material represented by LiFeₓMn_{1-x-y}M_{y}PO₄ (0.05≦x≦1.0, 0≦y≦0.14, here, M represents at least one element selected from Mg, Ca, Co, Sr, Ba, Ti, Zn, B, Al, Ga, In, Si, Ge, and rare earth elements) and a precursor of the electrode active material and an organic compound; and
loading the granulated body in a calcination vessel and thermally treating the granulated body in an inert atmosphere or a reducing atmosphere at a temperature of 700° C. or more and 1,000° C. or less,
wherein a concentration of the electrode active material and the precursor of the electrode active material in the slurry is 10% by mass or more and 30% by mass or less.
